(19) United States
(12) Patent Application Publication
(10) Pub. No.: US 2017/0317503 A1
(43) Pub. Date: Nov. 2, 2017

(54) POWER STORAGE CONTROL APPARATUS, DIRECT-CURRENT POWER SYSTEM, AND CONTROLLING METHOD THEREOF

(71) Applicant: OMRON Corporation, Kyoto-shi (JP)

(72) Inventors: Makoto OHASHI, Uji-shi (JP); Yoshihiko YAMAGUCHI, Kyoto-shi (JP)

(73) Assignee: OMRON Corporation, Kyoto-shi (JP)

(21) Appl. No.: 15/468,171

(22) Filed: Mar. 24, 2017

(30) Foreign Application Priority Data
Apr. 27, 2016 (JP) 2016-088888

(51) Int. Cl. H02J 3/38; H02J 3/46; H02S 40/38; H02J 7/35; H02S 40/32

(52) U.S. Cl. CPC H02J 3/385; H02J 7/35; H02S 40/32; H02S 40/38; H02J 3/46

(57) ABSTRACT

A power line interface is electrically connectable to a direct-current power system including a power line. A voltage sensor measures a first voltage value of direct current flowing through a power line. A bidirectional DC-DC convertor circuit is electrically connected to the power line interface. A controller receives the first voltage value measured by the voltage sensor and a power charge or discharge command value indicating an amount of power to charge the battery or an amount of power to be discharged from the battery, and controls the bidirectional DC-DC converter circuit based on the first voltage value and the power charge or discharge command value. The bidirectional DC-DC convertor circuit controls the first voltage value to approximate to a prescribed voltage value, and a current value of a direct current flowing between the bidirectional DC-DC converter circuit and the power line to approximate to a prescribed current value.

### CROSS REFERENCE TO RELATED APPLICATIONS

This application claims priority based on 35 USC 119 from prior Japanese Patent Applications No. 2016-088888 filed on Apr. 27, 2016, entitled “POWER STORAGE CONTROL APPARATUS”, the entire contents of which are hereby incorporated herein by reference.

### BACKGROUND

The disclosure relates to a power storage control apparatus.

Connecting direct-current power source such as a solar photovoltaic system, which includes a solar photovoltaic module and a power conditioner, to a commercial electrical grid and load equipment (power-using devices) has been exercised actively in recent years.

A power conditioner (hereinafter also referred to as a PCS (power conditioning system)) for a typical solar photovoltaic system generally performs maximum power point tracking to enable the solar photovoltaic system to extract maximum power from the solar photovoltaic module. However, due to output restrictions, solar photovoltaic systems that sell power may be prohibited from using all the power generated by the solar photovoltaic module, or in other words, may be permitted to extract only a smaller amount of power from the solar photovoltaic module than the maximum power that the solar photovoltaic module are capable of outputting. Also, solar photovoltaic systems that do not sell power may fail to use all the power generated by the solar photovoltaic module if load equipment consumes only a small amount of power.

Power generated by the solar photovoltaic module can be used more effectively if the PCS is modified to have a power storage function. However, such modification of the PCS is costly. For this reason, it has been proposed that an existing solar photovoltaic system be provided with a battery connected through a DC-DC converter to a power line which connects a solar photovoltaic module to a PCS having no power storage function, so that excess power can be stored in the battery. (See, for example, Japanese Patent Application Publication No. 02013-138530.

### SUMMARY

One or more embodiments of power storage control apparatus may include: a power line interface electrically connectable with a direct-current power system including a power line; a voltage sensor that measures a first voltage value of direct current flowing through the power line; a bidirectional DC-DC convertor circuit electrically connected to the power line interface, comprising a primary winding electrically connected to the power line interface, and a secondary winding electrically connected to a battery; the battery; and a controller that receives the first voltage value measured by the voltage sensor and a power charge or discharge command value indicating an amount of power to charge the battery or an amount of power to be discharged from the battery, and controls the bidirectional DC-DC converter circuit based on the first voltage value and the power charge or discharge command value, wherein the bidirectional DC-DC convertor circuit controls the first voltage value to approximate to a prescribed voltage value, and a current value of a direct current flowing between the bidirectional DC-DC converter circuit and the power line to approximate to a prescribed current value.

One or more embodiments of controlling method of a direct-current power system including a direct-current power source that generates power, a power conditioner that performs a maximum power point tracking and converts power outputted from the direct-current power source, and a power line connecting the direct-current power source and the power conditioner to each other, the power storage control apparatus, may include: measuring a first voltage value of the power line; obtaining a power charge or discharge command value indicating an amount of power to charge the battery or an amount of power to be discharged from the battery; and controlling a bidirectional DC-DC converter circuit electrically connected to the power line interface, comprising a primary winding electrically connected to the power line interface and a secondary winding electrically connected to the battery based on the first voltage value and the power charge or discharge command value to approximate a voltage value of a direct current flowing through the power line to a prescribed voltage value, and to approximate a current value of a direct current flowing between the bidirectional DC-DC converter circuit and the power line to a prescribed current value.

One or more embodiments of a direct-current power system may include: a direct-current power source that generates power; a power conditioner that performs maximum power point tracking and converts power outputted from the direct-current power source; and a power line connecting the direct-current power source and the power conditioner to each other; a power line interface electrically connected with the power line; a voltage sensor that measures a first voltage value of direct current flowing through the power line; a bidirectional DC-DC convertor circuit electrically connected to the power line interface, comprising a primary winding electrically connected to the power line interface and a secondary winding electrically connected to a battery; the battery; and a controller that receives the first voltage value measured by the voltage sensor and a power charge or discharge command value indicating an amount of power to charge the battery or an amount of power to be discharged from the battery, and controls the bidirectional DC-DC converter circuit based on the first voltage value and the power charge or discharge command value, wherein the bidirectional DC-DC convertor circuit controls the first voltage value to approximate to a prescribed voltage value, and a current value of a direct current flowing between the bidirectional DC-DC converter circuit and the power line to approximate to a prescribed current value.

### BRIEF DESCRIPTION OF DRAWINGS

FIG. 1 is a diagram illustrating a direct-current power system including a power storage control apparatus according to one or more embodiments;

FIG. 2 is a diagram illustrating an example hardware configuration of a DC-DC converter;

FIG. 3 is a diagram illustrating an example hardware configuration of a controller;

FIG. 4 is a flowchart of prescribed-value calculation processing performed by the controller; and

FIG. 5 is a diagram illustrating an example configuration of a DC-DC controller.

### DETAILED DESCRIPTION

Embodiments are explained with referring to drawings. In the respective drawings referenced herein, the same constituents are designated by the same reference numerals and duplicate explanation concerning the same constituents is basically omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

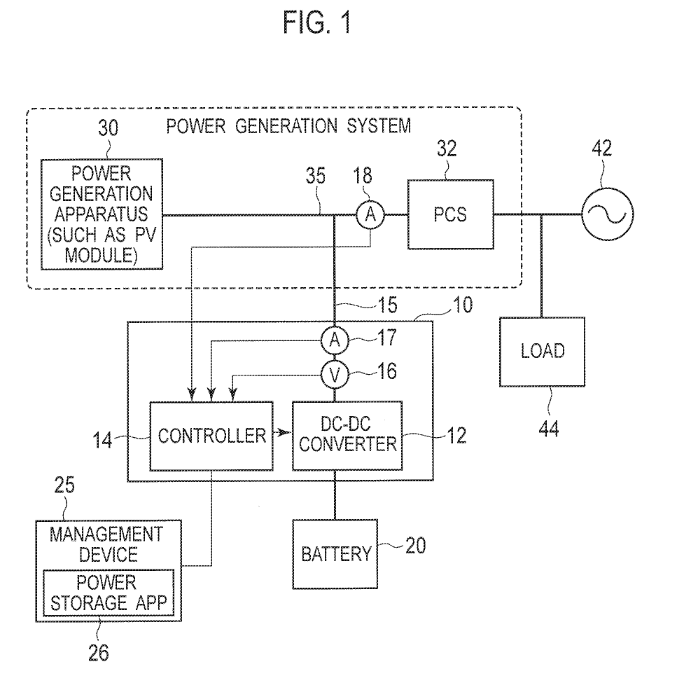

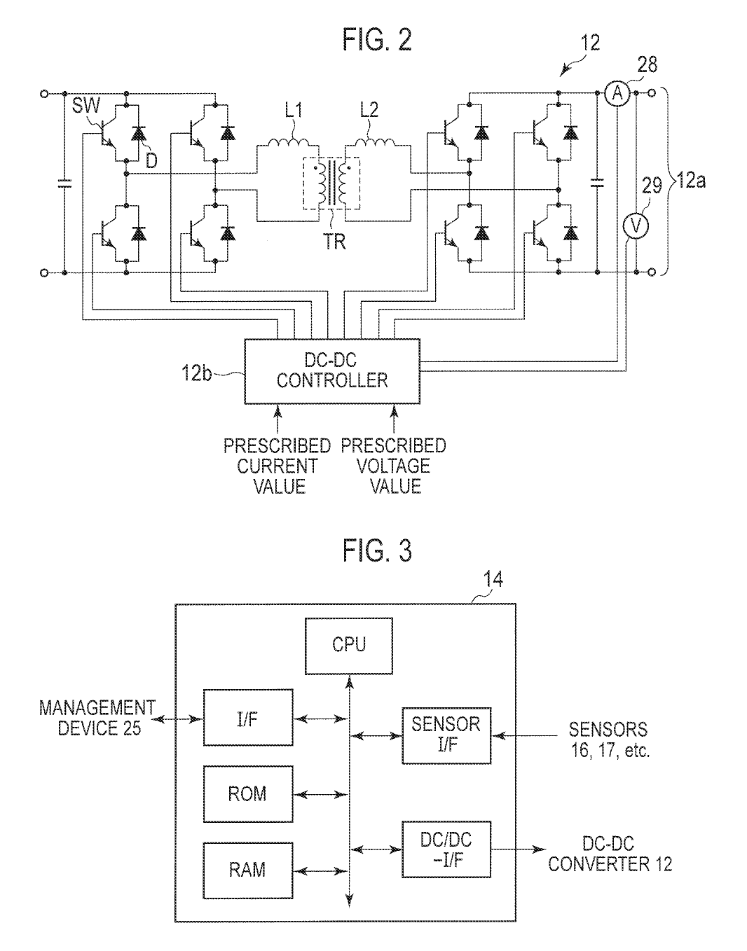

First, an overview of power storage control apparatus 10 according to the embodiment is provided using FIGS. 1 to 3. FIG. 1 is a diagram illustrating how power storage control apparatus 10 according to one or more embodiments is configured and used. FIG. 2 is a diagram illustrating an example hardware configuration of DC-DC converter 12, and FIG. 3 is a diagram illustrating an example hardware configuration of controller 14.

As depicted in FIG. 1, power storage control apparatus 10 may be, together with battery 20, added to an existing power generating apparatus. The power generation system used in combination with power storage control apparatus 10 has power generation apparatus 30 such as a solar photovoltaic (PV) module, and power conditioner (PCS) 32 which performs maximum power point tracking. The power generation apparatus may include natural energy electric generation apparatus using renewable energy such as sunlight, solar heat, hydraulic power, wind power, biomass, and geothermal power. Power generation apparatus 30 and PCS 32 are connected to each other by power line 35, and PCS 32 is connected to grid 42 and load 44.

Power storage control apparatus 10 provides the power generation system with a power storage ability. As illustrated in FIG. 1, power storage control apparatus 10 includes DC-DC converter 12 and controller 14. Management device 25, which is a computer having power storage application 26 installed therein, is connected to power storage control apparatus 10 (controller 14 in particular).

DC-DC converter 12 is bidirectional and connected to power line 35 and battery 20. As depicted in FIG. 1, DC-DC converter 12 is connected to power line 35 with power line 15. The power line 15 may include a power line interface connectable with a direct-current power system. The power line interface may be a detachable with a power line 35 of the direct-current power system. Provided on power line 15 are voltage sensor 16 that measures the voltage value of a direct current flowing through power line 15 and current sensor 17 that measures the current value of the direct current flowing through power line 15. Provided on power line 35 is current sensor 18 that measures the current value of a direct current flowing through power line 35.

DC-DC converter 12 may be a bidirectional DC-DC converter capable of charging battery 20 with power from power line 35 and outputting power discharged by battery 20 to power line 35. For example, DC-DC converter 12 may have the configuration depicted in FIG. 2. Specifically, DC-DC converter 12 may be an insulating, bidirectional converter including DC-DC conversion circuit 12a and DC-DC controller 12b . In DC-DC conversion circuit 12a , full-bridge circuits each formed by four switching elements SW and four diodes D are connected to the coils of a transformer TR via reactors L1 and L2, respectively. DC-DC controller 12b performs on/off control of the switching elements in DC-DC conversion circuit 12a . DC-DC conversion circuit 12a includes transformer TR including a primary winding electrically connected to power line interface, and a secondary winding electrically connected to a battery 20.

The input and output terminals depicted on the right side of FIG. 2 are connected to power line 15. Although outputs from current sensor 28 and current sensor 29 attached to DC-DC conversion circuit 12a are inputted to DC-DC controller 12b in FIG. 2 (details will be given later), outputs from current sensor 17 and voltage sensor 16 may be inputted to DC-DC controller 12b.

Controller 14 (FIG. 1) is a unit that controls DC-DC converter 12 so that charge or discharge power for battery 20 (power for charging battery 20 and power discharged by battery 20) may be adjusted to a power charge or discharge command value. The power charge or discharge command value is a target value of the charge or discharge power for battery 20 and is determined (computed) by power storage application 26 in management device 25 at intervals based on information from controller 14 (such as the level of power being supplied from power generation apparatus 30 or battery 20 to PCS 32), the present time, and the like, and then reported by power storage application 26 to controller 14.

As depicted in FIG. 1, controller 14 receives outputs from sensors 16 to 18.

The hardware configuration of controller 14 is not limited to a particular one. For example, controller 14 may be a unit having the configuration depicted in FIG. 3, or specifically, a unit including a CPU, a ROM, a RAM, an interface for management device 25, an interface for the sensors, and an interface for DC-DC converter 12.

The operation of controller 14 and of DC-DC controller 12b are described below. In the following description, a voltage value and a current value of a direct current flowing through power line 35 (or 15) are referred to as a voltage value and a current value of power line 35 (or 15), respectively.

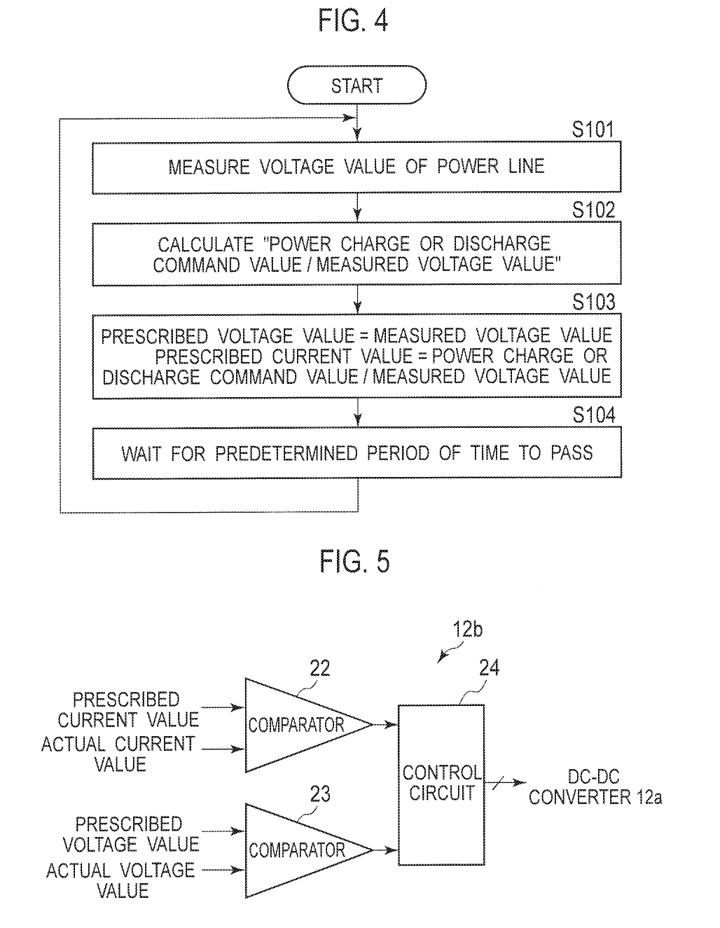

Controller 14 of power storage control apparatus 10 according to this embodiment is configured (programmed) to execute prescribed-value calculation processing, the procedure of which is illustrated in FIG. 4.

Specifically, in the prescribed-value calculation processing (FIG. 4), controller 14 first measures a voltage value of power line 35 (Step S101). Processing actually performed in Step S101 is to acquire, from voltage sensor 16, a voltage value of power line 15 that matches a voltage value of power line 35.

Next, controller 14 divides the power charge or discharge command value most recently reported from power storage application 26, by the voltage value of power line 35 measured in Step S101 (Step S102). Then, controller 14 determines that the measured voltage value and the quotient of the division in Step S102 are respectively a prescribed voltage value and a prescribed current value, which are inputted to DC-DC converter 12 (DC-DC controller 12b ) as control parameters (Step S103).

In the prescribed-value calculation processing, controller 14 waits for a predetermined period of time to pass (Step S104). The predetermined period of time is a preset period of time (e.g., 0.2 second) which is longer than the switching cycle of DC-DC controller 12b and shorter than the control cycle of the maximum power point tracking (so that the changes in the voltage value of power line 35 made by the maximum power point tracking may be detectable).

Then, after Step S104, the prescribed-value calculation processing proceeds back to Step S101 to start from Step S101 again.

DC-DC controller 12b is a unit that iterates processing for controlling the switching elements in DC-DC conversion circuit 12a at short intervals (approximately at an interval of 1/(20k)) so that the voltage value of power line 35 may approximate to the prescribed voltage value and the current value of power line 35 may approximate to the prescribed current value.

By the control performed by DC-DC controller 12b , the voltage value of power line 35 may exceed the prescribed voltage value for a short period of time. Thus, DC-DC controller 12b may have the configuration depicted in FIG. 5. In DC-DC controller 12b depicted in FIG. 5, comparator 22 is a circuit that outputs a signal indicative of whether “prescribed current value =actual current value” is true, and comparator 23 is a circuit that outputs a signal indicative of whether “prescribed voltage value=actual voltage value” is true. When at least one of “prescribed current value=actual current value” and “prescribed voltage value =actual voltage value” is not true, control circuit 24 controls DC-DC conversion circuit 12a so that one or both of a voltage value and a current value of power line 15 may increase or decrease. When both of “prescribed current value =actual current value” and “prescribed voltage value =actual voltage value” are true, control circuit 24 controls DC-DC conversion circuit 12a so that the voltage value and the current value of power line 15 may not change.

The power storage control apparatus 10 according to this embodiment is configured as described above. Thus, when power storage control apparatus 10 is used, the amounts of power transferred between power storage control apparatus 10 and power line 35 may fall below the power charge or discharge command value for a short period of time, but while the battery 20 is being charged or discharging, the voltage value of power line 35 deviates little from the voltage value controlled by PCS 32 using maximum power point tracking.

Hence, without adversely affecting the maximum power point tracking performed by PCS 32, the power storage control apparatus 10 can control charging or discharging of battery 20 by controlling the amount of charge or discharge power to make this amount equal the power charge or discharge command value.

<<Modification>>

Power storage control apparatus 10 described above can be modified variously. For example, controller 14 may be provided to determine the “predetermined period of time” (FIG. 4) in the prescribed-value calculation processing based on the control cycle of the maximum power point tracking performed by PCS 32, which cycle is obtained based on the temporal change in the voltage value of power line 35. Additionally, controller 14 may be provided with the role of DC-DC controller 12b and/or the role of management device 25.

As in the related art described earlier, a power storage such as a battery can be inexpensively added to an existing solar photovoltaic system that uses a PCS incapable of power storage, by connecting a battery to the power line of the solar photovoltaic system through a DC-DC converter. However, this poses the following problem. Specifically, the PCS performs maximum power point tracking in which the voltage value of the power line is varied (increased or decreased) and thereby controlled to be a voltage value that maximizes power extraction. Control performed for charge and discharge of the battery may also vary the voltage value of the power line. Thus, if simple control such as constant voltage control or constant current control is performed on the DC-DC converter connected to the power line, this control may interfere with the maximum power point tracking performed by the PCS, preventing maximum power extraction from the solar photovoltaic module.

Such a problem also occurs in a case where a battery is connected, through a DC-DC converter, to the power line of a power generation system including a power generation apparatus other than a solar photovoltaic module (such as a wind power generation apparatus) and a PCS performing maximum power point tracking.

The power storage control apparatus of the examples described above is configured so that, when the battery is charged or discharging, the voltage value of the power line may deviate little from the voltage value controlled by the PCS using maximum power point tracking. Thus, when the power storage control apparatus of the present invention is used, a power storage function can be given to the power generation system without adversely affecting the maximum power point tracking performed by the PCS.

The above examples can provide a power storage control apparatus which is connected to a battery and to the power line of a power generation system including a PCS performing maximum power point tracking, and which is capable of giving a power storage function to the power generation system without adversely affecting the maximum power point tracking performed by the PCS.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A power storage control apparatus, comprising:
a power line interface electrically connectable to a direct-current power system including a power line;
a voltage sensor that measures a first voltage value of direct current flowing through the power line;
a bidirectional DC-DC convertor circuit electrically connected to the power line interface, comprising a primary winding electrically connected to the power line interface, and a secondary winding electrically connected to a battery;
the battery; and
a controller that receives the first voltage value measured by the voltage sensor and a power charge or discharge command value indicating an amount of power to charge the battery or an amount of power to be discharged from the battery, and controls the bidirectional DC-DC converter circuit based on the first voltage value and the power charge or discharge command value, wherein
the bidirectional DC-DC convertor circuit controls the first voltage value to approximate to a prescribed voltage value, and a current value of a direct current flowing between the bidirectional DC-DC converter circuit and the power line to approximate to a prescribed current value.

2. The power storage control apparatus according to claim 1, wherein
the controller comprises a prescribed-value calculator that calculates the prescribed voltage value and the prescribed current value based on the first voltage value and the power charge or discharge command value .

3. The power storage control apparatus according to claim 2, wherein
the prescribed-value calculator calculates the prescribed voltage value and the prescribed current value iterately at predetermined interval.

4. The power storage control apparatus according to claim 2, wherein
the controller controls the bidirectional DC-DC converter circuit based on the first voltage value and the power charge or discharge command value iterately at a first interval.

5. The power storage control apparatus according to claim 4, wherein
the prescribed-value calculator calculates the prescribed voltage value and the prescribed current value iterately at a second interval that is longer than the first interval.

6. The power storage control apparatus according to claim 2, wherein
the prescribed-value calculator performs calculating process including:
setting the prescribed voltage value as the first voltage value; and
calculating the prescribed current value a quotient of a division of the power charge or discharge command value by the first voltage value.

7. A controlling method of a direct-current power system including a direct-current power source that generates power, a power conditioner that performs a maximum power point tracking and converts power outputted from the direct-current power source, and a power line connecting the direct-current power source and the power conditioner to each other, the power storage control apparatus, comprising:
measuring a first voltage value of the power line;
obtaining a power charge or discharge command value indicating an amount of power to charge the battery or an amount of power to be discharged from the battery; and
controlling a bidirectional DC-DC converter circuit electrically connected to the power line interface, comprising a primary winding electrically connected to the power line interface and a secondary winding electrically connected to the battery based on the first voltage value and the power charge or discharge command value to approximate a voltage value of a direct current flowing through the power line to a prescribed voltage value, and to approximate a current value of a direct current flowing between the bidirectional DC-DC converter circuit and the power line to a prescribed current value.

8. The controlling method according to claim 7, wherein
the controlling the bidirectional DC-DC converter comrprises:
setting the prescribed voltage value as the first voltage value; and
calculating the prescribed current value a quotient of a division of the power charge or discharge command value by the first voltage value.

9. A direct-current power system, comprising:
a direct-current power source that generates power;
a power conditioner that performs maximum power point tracking and converts power outputted from the direct-current power source;
a power line connecting the direct-current power source and the power conditioner to each other;
a power line interface electrically connected to the power line;
a voltage sensor that measures a first voltage value of direct current flowing through the power line;
a bidirectional DC-DC convertor circuit electrically connected to the power line interface, comprising a primary winding electrically connected to the power line interface and a secondary winding electrically connected to a battery;
the battery; and
a controller that receives the first voltage value measured by the voltage sensor and a power charge or discharge command value indicating an amount of power to charge the battery or an amount of power to be discharged from the battery, and controls the bidirectional DC-DC converter circuit based on the first voltage value and the power charge or discharge command value, wherein
the bidirectional DC-DC convertor circuit controls the first voltage value to approximate to a prescribed voltage value, and a current value of a direct current flowing between the bidirectional DC-DC converter circuit and the power line to approximate to a prescribed current value.

10. The direct-current power system according to claim 9, wherein
the power generation apparatus is a solar photovoltaic cell.

11. The direct-current power system according to claim 9, wherein
the controller comprises a prescribed-value calculator that calculates the prescribed voltage value and the prescribed current value based on the first voltage value and the power charge or discharge command value .

12. The direct-current power system according to claim 11, wherein
the prescribed-value calculator calculates the prescribed voltage value and the prescribed current value iterately at predetermined interval.

13. The direct-current power system according to claim 11, wherein
the controller controls the bidirectional DC-DC converter circuit based on the first voltage value and the power charge or discharge command value iterately at a first interval.

14. The direct-current power system according to claim 13, wherein
the prescribed-value calculator calculates the prescribed voltage value and the prescribed current value iterately at a second interval that is longer than the first interval.

15. The direct-current power system according to claim 9, wherein
the prescribed-value calculator performs calculating process including:
setting the prescribed voltage value as the first voltage value; and
calculating the prescribed current value a quotient of a division of the power charge or discharge command value by the first voltage value.

16. The direct-current power system according to claim 9, wherein
the proscribed-value calculator iterately calculates based on the control cycle of a maximum power point tracking performed by the power conditioner, which cycle is obtained by detecting a temporal change in the first voltage value.
